(19) United States
(12) Patent Application Publication
(10) Pub. No.: US 2012/0233753 A1
(43) Pub. Date: Sep. 20, 2012

(54) Waterless Urinal Conversion Assembly

(76) Inventor: Andreas Baer, Carmel, CA (US)

(21) Appl. No.: 13/419,980

(22) Filed: Mar. 14, 2012

Related U.S. Application Data
(60) Provisional application No. 61/453,218, filed on Mar. 16, 2011.

(51) Int. Cl. A47K 11/00; B23P 17/04

(52) U.S. Cl. 4/144.1; 29/428

(57) ABSTRACT

An apparatus and method relating to a waterless urinal assembly capable of being mounted, molded, or assembled upon a conventional urinal. The waterless urinal assembly comprises mainly a bowl assembly and a waterless urinal cartridge. An implementation of the apparatus includes a sheathing configured to seal the waterless urinal cartridge upon the bowl assembly. A further implementation includes an adapter piece configured to releasably couple to the sheathing and a waste hose configured to couple with the adapter piece. The waste hose may then be inserted through the waste line of the conventional urinal. The conversion of a conventional urinal into a waterless or semi-waterless urinal promotes water conservation and reduces costs associated with maintenance while preventing the spread of harmful bacteria in lavatories.

This application claims the benefit of U.S. Provisional Application 61/453,218, filed Mar. 16, 2011, hereby incorporated by reference.

### FIELD

The present disclosure relates to waterless or semi-waterless urinals, in particular, a waterless urinal assembly capable of being installed upon conventional urinals.

### BACKGROUND

With water becoming a scarcer and more valuable resource, society is being pressured to develop methods and devices that promote its conservation. Furthermore, in order to save water, money, and to prevent the spread of germs, conventional urinals are widely being replaced by waterless urinals. However, the initial cost of a replacing a conventional urinal with a waterless urinal can be quite high for everyday business owners, and even local and state governments. Typically, a contractor must be hired to tear out the conventional urinal and install a waterless urinal in its place. The present disclosure relates to a waterless urinal assembly configured to be installed upon a conventional urinal, thereby reducing costs associated with replacing conventional urinals with waterless urinals, conserving water, and preventing the spread of germs.

### SUMMARY

An embodiment of the waterless urinal assembly includes a bowl assembly and a waterless urinal cartridge. The waterless urinal cartridge may be configured to releasably attach to the bowl assembly. The bowl assembly is configured to be mounted or formed to a convention urinal such that an attached waterless urinal cartridge is proximate to the waste opening of the conventional urinal. A typical conventional urinal comprises a flush assembly, a vertical portion, and a bowl portion with a waste opening connecting the conventional urinal to a waste line. The waterless urinal assembly may include an attached hose configured to be inserted into the waste line of a conventional urinal. The waterless urinal cartridge may also be configured to be at least partially inserted into the waste opening of a conventional urinal. The bowl assembly may be mounted or formed to the conventional urinal using a petroleum-based, or other practical adhesive substance.

The bowl assembly of an embodiment of the present disclosure includes an aperture, and may be configured to be mounted or formed upon the bowl portion of a conventional urinal, wherein the aperture of the bowl assembly parallels the waste opening of the conventional urinal. The bowl assembly may be substantially concave and include a lowest point. The lowest point of the bowl assembly forms the aperture upon which the waterless urinal cartridge may be releasably attached. The aperture of the bowl assembly may also be formed around the waterless urinal cartridge, wherein the waterless urinal cartridge is located proximate to the lowest point of the bowl assembly.

Another embodiment of the present disclosure includes a sheathing which may be configured to attach to the aperture of the bowl assembly, and which may be included to facilitate in sealing the waterless urinal cartridge and the bowl assembly. An adapter piece with a cartridge end and a waste end may be included. The adapter piece may be used to further connect the waterless urinal cartridge to the waste line of a conventional urinal. The cartridge end of the adapter piece may be configured to releasably couple to the sheathing. The waste end of the adapter piece may be configured to releasably couple to a waste hose. The waste hose may be inserted into the waste opening and travel at least partially through the waste line of a conventional urinal. This implementation permits running liquid waste from the bowl portion of a conventional urinal, over the bowl assembly, through the waterless urinal cartridge and adapter piece, and then through the waste hose, exiting into the waste line. A gasket may be disposed around the waterless urinal cartridge to provide a seal between the waterless urinal cartridge and the sheathing. A gasket may also be disposed around the adapter piece to provide a seal between the adapter piece and the waste opening of the conventional urinal.

The waste hose may have a secure end and an exit end. The secure end of the waste hose may be releasably coupled to the adapter piece. The exit end of the waste hose may be inserted at least partially into the waste line of the conventional urinal.

In practice, liquid waste is dispersed upon the bowl assembly itself or the vertical or bowl portion of the conventional urinal, and funneled over the bowl assembly and into the waterless urinal cartridge. The liquid waste then passes through the attached waterless urinal cartridge and eventually out through the waste line. Thus, the conventional urinal has been converted to function as a waterless or semi-waterless urinal. An advantage of the present disclosure is that it may be self-cleaning since the converted urinal may still retain flushing capability, thereby eliminating undesirable odors caused by continued use over time and reducing costs associated with maintenance.

The details of one or more of the implementations are set forth in the accompanying drawings and the description below. Other features and advantages will become apparent from the description, the drawings, and the claims.

### BRIEF DESCRIPTION OF THE DRAWINGS

FIG. 1 is a cross-sectional diagram of an implementation of a basic embodiment of the present disclosure.

FIG. 2 is an exploded frontal view of the basic embodiment of FIG. 1.

FIG. 3 is a diagram the basic embodiment of FIG. 1.

FIG. 4 is a frontal cross-sectional diagram of an implementation of an exemplary embodiment of the present disclosure.

FIG. 5 is an exploded view of the exemplary embodiment of FIG. 4.

FIG. 6 is a diagram of the exemplary embodiment of FIG. 4.

FIG. 7 is a flow diagram of a method of installing a basic embodiment of the present disclosure.

FIG. 8 is a flow diagram of a method of installing an exemplary embodiment of the present disclosure.

### DETAILED DESCRIPTION

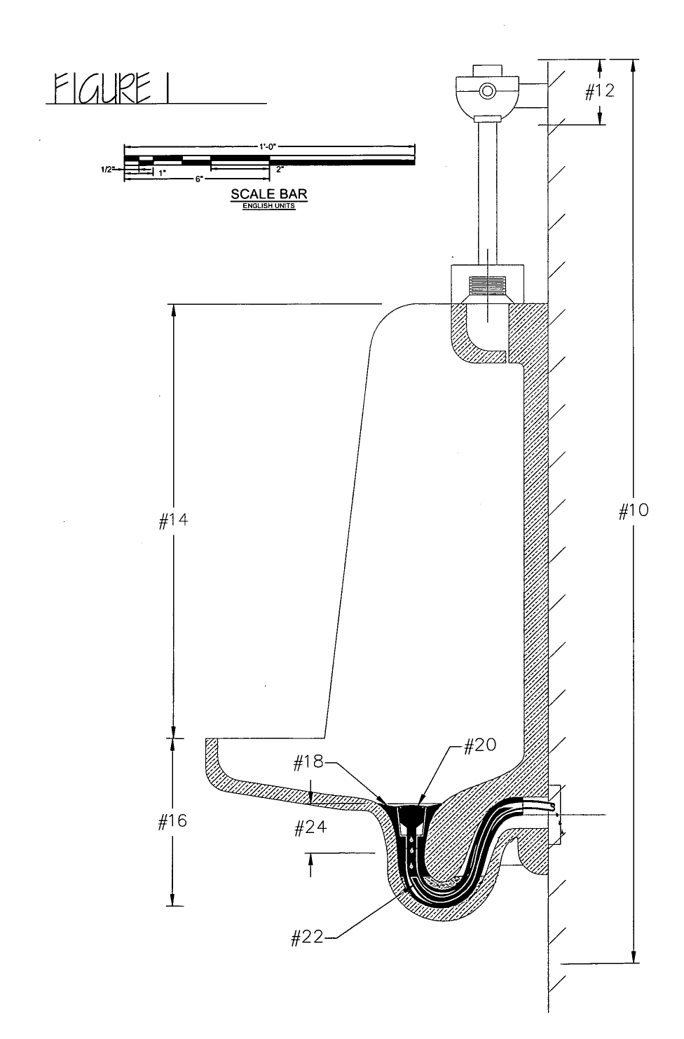

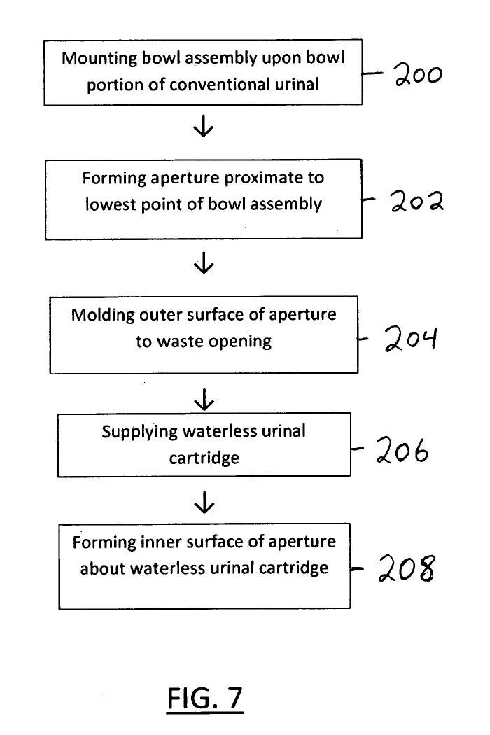

An implementation of the waterless urinal assembly 24 in FIGS. 1 and 7 includes a bowl assembly 18 mounted 200 to a bowl portion 16 of a conventional urinal 10. The conventional urinal 10 is made up of a flush assembly 12, a vertical portion 14, and a bowl portion 16. The bowl assembly 18 may be formed 210 or mounted 200 to the bowl portion 16 of the conventional urinal 10. In the embodiment, an aperture 36, with an inner surface 42 and an outer surface 44, is formed 202 proximate to the lowest point 34 of the bowl assembly 18. The outer surface 44 of the aperture is molded 204 to the waste opening 40 of the conventional urinal 10. In the embodiment, a waterless urinal cartridge 20 with an outer surface 60 is supplied 206. The inner surface 42 of the aperture 36 is formed 208 about the outer surface 60 of the waterless urinal cartridge 20. The outer surface 60 of the waterless urinal cartridge 20 is sealed to the inner surface 42 of the aperture, allowing liquid waste dispensed upon the vertical portion 14 or bowl portion 16 of the conventional urinal 10 to flow through the waterless urinal cartridge 20 and into the waste line 22 of the conventional urinal 10.

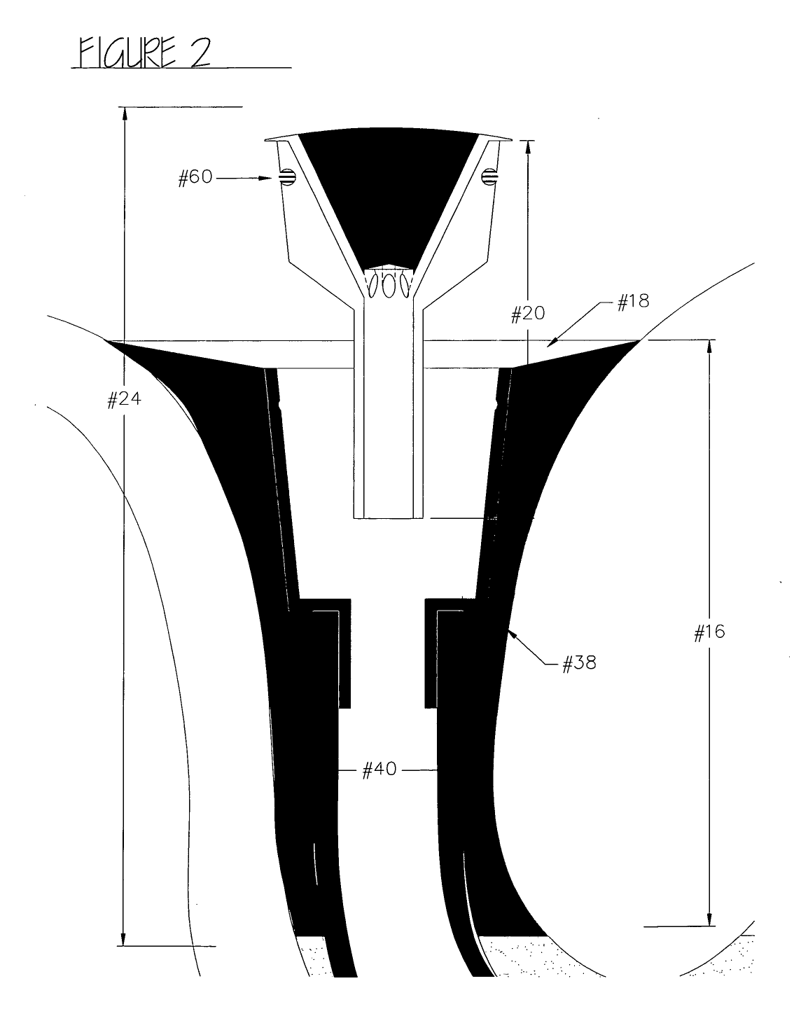

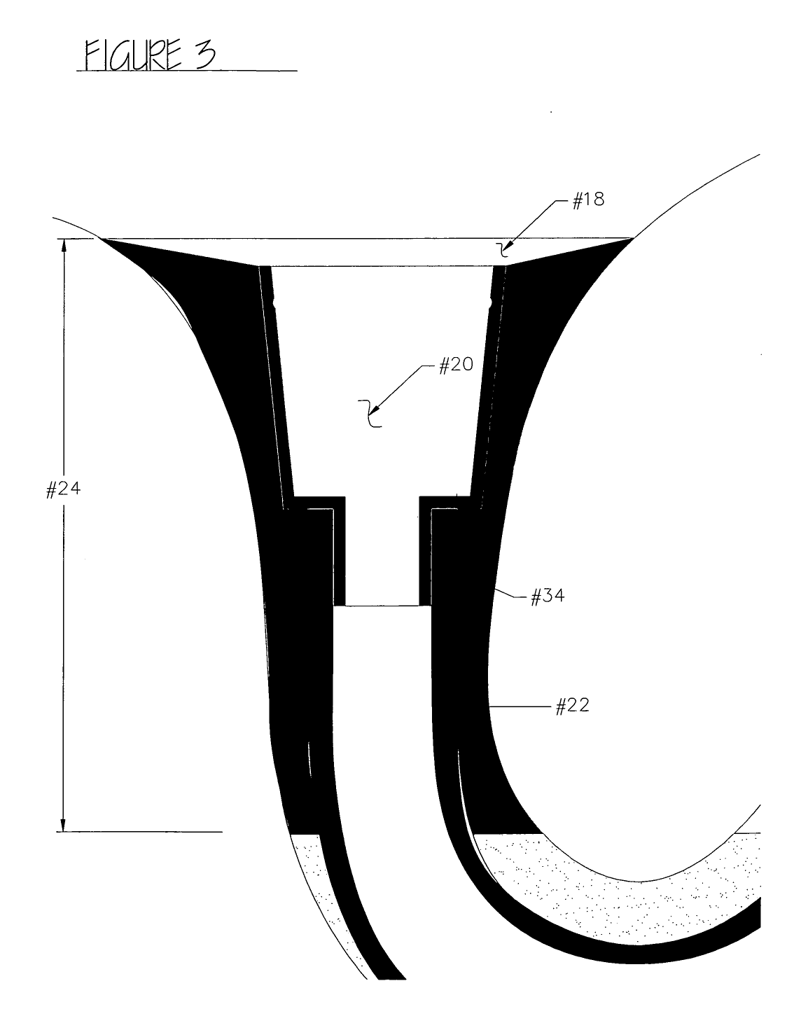

Referring to FIG. 2—an exploded frontal view of the embodiment in FIG. 1—and FIG. 3—a diagram of the embodiment in FIG. 1; the waterless urinal assembly 24 includes a bowl assembly 18 which is formed to the lowest point 38 of the bowl portion 16. The bowl assembly 18 is sealed to the outer surface 60 of the waterless urinal cartridge 20. Liquid waste dispensed upon the vertical portion 14 or bowl portion 16 is channeled over the bowl assembly 18 and into the waterless urinal cartridge 20. It then proceeds past the lowest point 34 of the bowl assembly 18 and into the waste line 22.

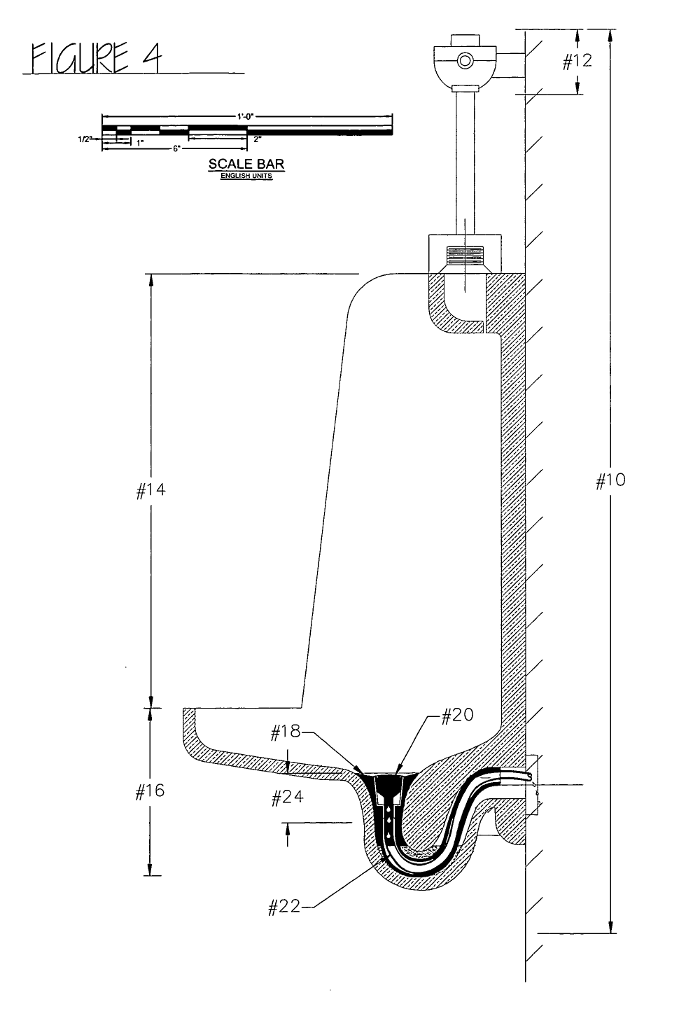

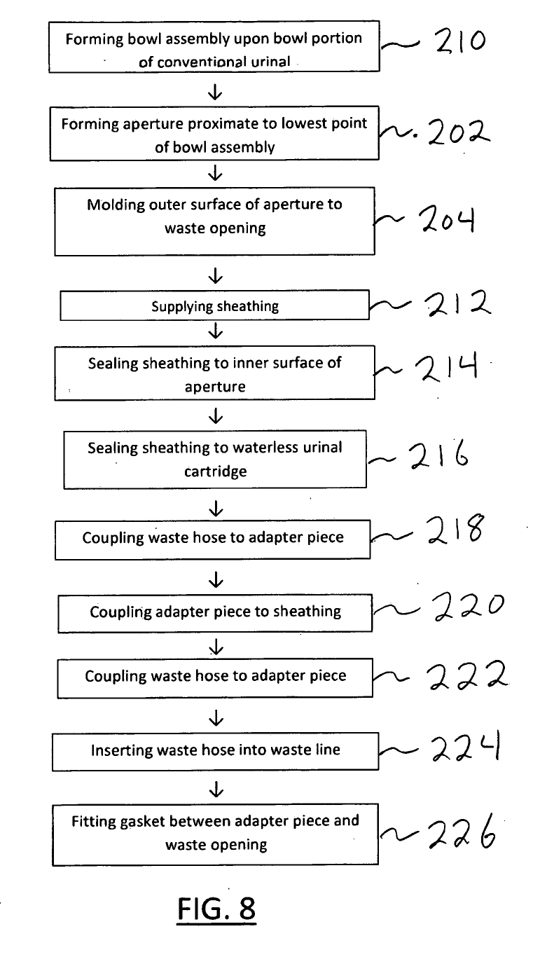

Referring to FIGS. 4 and 8, an exemplary embodiment of the present disclosure includes a bowl assembly 18 formed 210 upon a bowl portion 16 of a conventional urinal 10. The conventional urinal 10 is made up of a flush assembly 12, a vertical portion 14, and a bowl portion 16. A sheathing 26 is supplied 212, and the bowl assembly 18 is further sealed 214 to the sheathing 26. An adapter piece 28 is releasably coupled 220 to the sheathing 26, and a gasket 32 is fitted 226 to seal the adapter piece 28 with the waste line 22. A waste hose 30 is coupled 222 with the adapter piece 28, and further inserted 224 into the waste line 22. A waterless urinal cartridge 20 is sealed 216 to the sheathing 26, allowing waste to channel over the bowl assembly 18, through the waterless urinal cartridge 20, passing through the adapter piece 28, into the waste hose 30, and out through the waste line 22.

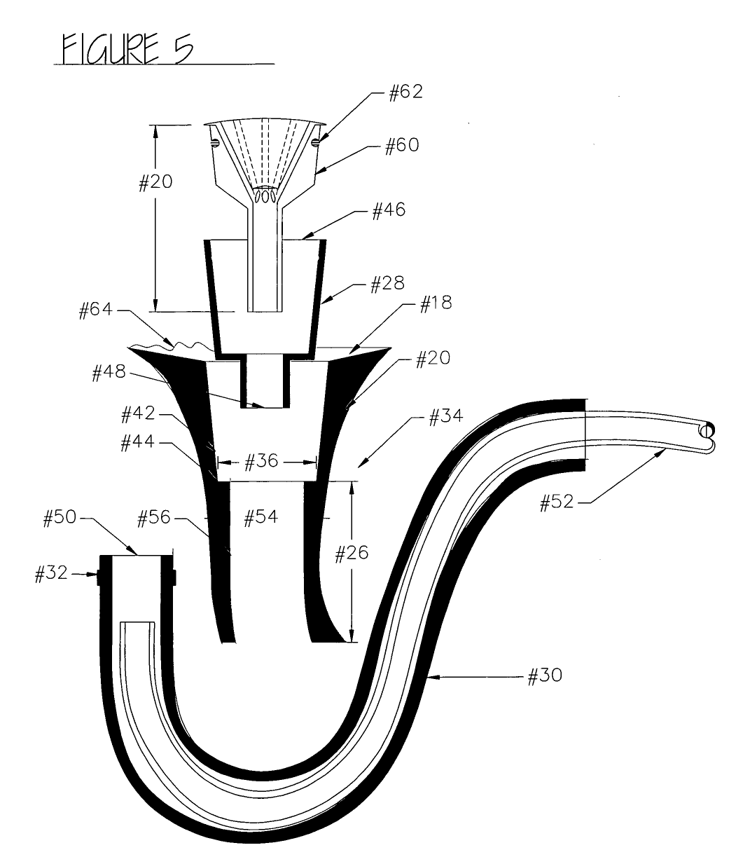

Referring to FIGS. 5 and 8, the bowl assembly 18 of the waterless urinal assembly 24 is formed 210 of a petroleum-based adhesive substance 64, to the bowl portion 16 of a conventional urinal 10. The lowest point 34 of the bowl assembly forms 202 an aperture 36 with an inner surface 42 and an outer surface 44. The outer surface 44 of the aperture 36 is molded 204 to the waste opening 40 of the conventional urinal 10. A sheathing 26, with an inner surface 54 and an outer surface 56, is supplied 212. The outer surface 56 of the sheathing 26 is sealed 214 to the inner surface 42 of the aperture 36. The outer surface 60 of a waterless urinal cartridge 20 is sealed 216 to the inner surface 54 of the sheathing 26. Furthermore, the embodiment implements a gasket 62 to assist further in sealing the outer surface 60 of the waterless urinal cartridge 20 to the inner surface 54 of the sheathing 26. The embodiment in FIG. 5 further includes an adapter piece 28 with a cartridge end 46 and a waste end 48. The waterless urinal cartridge 20 sits within the adapter piece 28, and the cartridge end 46 of the adapter piece 28 is releasably coupled 220 to the sheathing 26. The embodiment further includes a waste hose 30 which has a secure end 50 and an exit end 52. The waste end 48 of the adapter piece 28 is releasably coupled 218 to the secure end 50 of the waste hose 30. The exit end 52 of the waste hose 30 is inserted 224 into the waste line 22 of the conventional urinal 10. Finally, in this embodiment, a gasket 32 is included to be fitted 226 between the adapter piece 28 and the waste opening 40 of the conventional urinal 10.

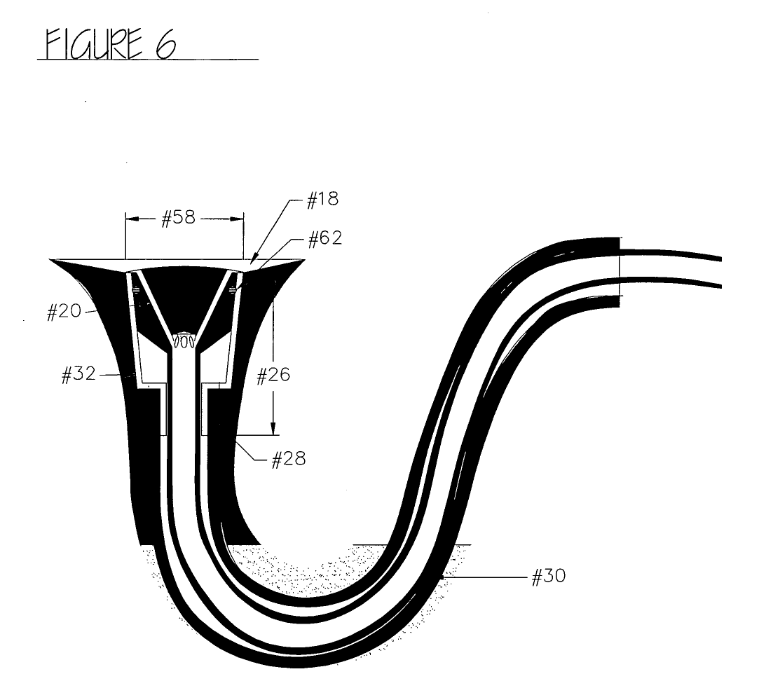

Referring to FIG. 6—a diagram of an exemplary embodiment of the present disclosure—the waterless urinal assembly 24 includes a bowl assembly 18 that forms 202 an aperture 36. The aperture 36 is configured to be sealed 214 with the outer surface 56 of a sheathing 26. Furthermore, the outer surface 60 of a waterless urinal cartridge 20 is configured to be sealed 216 to the inner surface 54 of the sheathing 26. The configuration is such that a defined seal 58 is created between the inner surface 42 of the aperture 36, the sheathing 26 and the outer surface 60 of the waterless urinal cartridge 20. A gasket 62 is included in the embodiment to further assist in the defined seal 58. An adapter piece 28 is coupled 220 to the sheathing 26, and further coupled 222 to a waste hose 30. Another gasket 32 is included to be fitted 226 between the adapter piece 28 and the waste opening 40 of a conventional urinal 10.

What is claimed is:

1. A waterless urinal assembly for installation upon a conventional urinal typically found in men's lavatories, said conventional urinal typically comprising a flush assembly, a vertical portion below said flush assembly, a bowl portion with a first lowest point below said vertical portion, a waste opening proximate to said first lowest point of said bowl portion, and a waste line connected to said waste opening; said waterless urinal assembly comprising:
a substantially concave bowl assembly capable of being molded upon said bowl portion of said conventional urinal, said bowl assembly having a second lowest point and an aperture proximate to said second lowest point; and
a waterless urinal cartridge with a first outer surface, said first outer surface of said cartridge configured to be sealed upon said aperture of said bowl assembly.

2. The waterless urinal assembly of claim 1 further comprising a sheathing having a second outer surface and a first inner surface; said second outer surface configured to create a seal upon said aperture of said bowl assembly; said first inner surface configured to create a seal upon said first outer surface of said waterless urinal cartridge.

3. The waterless urinal assembly of claim 2 further comprising an adapter piece with a cartridge end and a waste end; said cartridge end being configured to releasably attach to said sheathing; said waste end configured to be inserted upon said waste opening of said conventional urinal.

4. The waterless urinal assembly of claim 3 further comprising a waste hose having a secure end and an exit end, said secure end being configured to releasably attach to said waste end of said adapter piece, said exit end configured to be at least partially inserted into said waste line of said conventional urinal.

5. The waterless urinal assembly of claim 4 wherein said waste end of said adapter piece is threaded, thereby permitting said waste hose to be screwed upon said waste end.

6. The waterless urinal assembly of claim 4 further comprising a first gasket configured to seal said waste end of said adapter piece upon said waste opening of said conventional urinal.

7. The waterless urinal assembly of claim 4 further comprising a second gasket configured to seal said sheathing upon said waterless urinal cartridge.

8. The waterless urinal assembly of claim 4 wherein said bowl assembly is formed of a petroleum-based adhesive substance, said substance being capable of being molded.

9. A method of installing a waterless urinal assembly upon a conventional urinal; said conventional urinal comprising a flush assembly, a vertical portion below said flush assembly, a bowl portion with a first lowest point below said vertical portion, a waste opening proximate to said first lowest point, and a waste line connected to said waste opening; the method comprising:
forming a bowl assembly having a second lowest point upon said bowl portion of said conventional urinal;
forming an aperture having a second inner surface and a third outer surface, proximate to said second lowest point of said bowl assembly;
molding said third outer surface of said aperture to said waste opening of said conventional urinal;
supplying a waterless urinal cartridge having a first outer surface; and
forming said second inner surface of said aperture about said first outer surface of said waterless urinal cartridge.

10. The method of claim 9 wherein the step of mounting said bowl assembly is replaced by forming said bowl assembly upon said bowl portion of said conventional urinal using a petroleum-based adhesive substance, said substance being capable of being molded.

11. A method of installing a waterless urinal assembly upon a conventional urinal; said conventional urinal comprising a flush assembly, a vertical portion below said flush assembly, a bowl portion with a first lowest point below said vertical portion, a waste opening proximate to said first lowest point, and a waste line connected to said waste opening; the method comprising:
forming a bowl assembly having a second lowest point upon said bowl portion of said conventional urinal;
forming an aperture having a second inner surface and a third outer surface, proximate to said second lowest point of said bowl assembly;
molding said third outer surface of said aperture to said waste opening of said conventional urinal;
supplying a waterless urinal cartridge having a first outer surface;
supplying a sheathing having a first inner surface and a second outer surface;
sealing said second outer surface of said sheathing upon said second inner surface of said aperture; and
sealing said first inner surface of said sheathing upon said first outer surface of said waterless urinal cartridge.

12. The method of claim 11 further comprising coupling an adapter piece having a cartridge end and a waste end; to said sheathing, thereby creating a seal between said cartridge end of said adapter piece and said sheathing.

13. The method of claim 12 further comprising coupling a waste hose to said waste end of said adapter piece.

14. The method of claim 13 further comprising inserting said waste hose into said waste line of said conventional urinal.

15. The method of claim 12 wherein said waste end of said adapter piece is threaded, thereby permitting said waste hose to be screwed upon said waste end.

16. The method of claim 12 further comprising fitting a first gasket between said waste end of said adapter piece and said waste opening of said conventional urinal.

17. The method of claim 12 further comprising fitting a second gasket between said sheathing and said waterless urinal cartridge.
